(19) United States
(12) Patent Application Publication
(10) Pub. No.: US 2026/0230371 A1
(43) Pub. Date: Aug. 6, 2026

(54) MONITORING DEVICE

(71) Applicant: FANUC CORPORATION, Minamitsuru-gun, Yamanashi (JP)

(72) Inventor: Yuma HIRONAKA, Yamanashi (JP)

(21) Appl. No.: 19/149,662

(22) PCT Filed: Mar. 8, 2023
(86) PCT No.: PCT/JP2023/008875

§ 371 Date: Jul. 21, 2025

(51) Int. Cl. H04L 41/06

(52) U.S. Cl. CPC H04L 41/06

(57) ABSTRACT

This monitoring device monitors a network system composed of a plurality of constituent elements including an industrial machine, a server, a peripheral apparatus, and a network apparatus, said industrial machine including at least a robot, and comprises: at least one memory that stores a network diagram indicating the connection condition of the plurality of constituent elements, and data indicating the statuses of the plurality of constituent elements; at least one processor; and a display unit, wherein the at least one processor identifies at least one constituent element among the plurality of constituent elements, monitors the communication status of the identified constituent element on the basis of the data, and if the communication of the identified constituent element is disrupted, displays information indicating the disruption of the communication of the constituent element on the display unit together with the network diagram.

### TECHNICAL FIELD

The present disclosure relates to a monitoring device for monitoring a network system including a robot.

### BACKGROUND ART

In a technique that has been known in the art, a robot monitoring system enables predictive maintenance via an algorithm for predicting a failure and preventive maintenance where the timing for replacing an object such as a battery to be replaced at a determined timing is notified, monitors an alarm condition of a robot, and informs a system/facility manager of an anomalous condition. The robot monitoring system is operated after construction of a network including one or more robots and a server of the robot monitoring system. See, for example, Patent Document 1.

A network diagram visualizes how devices forming the network are connected together. Such a network diagram is required for network management, troubleshooting, and other purposes, and is created and managed by many network administrators.

### CITATION LIST

### Patent Document

Patent Document 1: Japanese Unexamined Patent Application, Publication No. 2015-131381

### DISCLOSURE OF THE INVENTION

### Problems to be Solved by the Invention

In the known technique, when a problem associated with the network occurs during introduction or operation of the robot monitoring system, a solution to the problem needs to be searched for using log check or a function of an operating system (OS) itself.

In the known technique, the degree of difficulty in grasping the configuration of the network to which the robots under present conditions are connected increases in proportion to an increase in the size of the network. Thus, an error may occur in an unexpected location, and the time required to solve the problem increases.

To address this problem, it is desirable to easily grasp the status of a network and an error by monitoring a network system including a robot and visually displaying the status of the network using a network diagram or any other method based on the result of monitoring.

### Means for Solving the Problems

An aspect of the present disclosure is directed to a monitoring device for monitoring a network system having a plurality of components including an industrial machine, a server, a peripheral device, and a network device. The industrial machine includes at least a robot. The monitoring device includes: at least one memory configured to store a network diagram that shows a condition of connection between the plurality of components in the network system and data that indicate states of the plurality of components; at least one processor; and a display. The at least one processor is configured to recognize at least one of the plurality of components, monitor a state of communication of the at least one of the components recognized based on the data, and display information that indicates a communication blackout in the at least one of the components recognized and the network diagram on the display in a case in which the communication blackout has occurred in the at least one of the components.

### BRIEF DESCRIPTION OF THE DRAWINGS

FIG. 1 shows an exemplary configuration of a robot monitoring system according to one embodiment;

FIG. 2 shows an exemplary functional configuration of a monitoring device;

FIG. 3 shows an exemplary screen displaying a network diagram in a normal state;

FIG. 4 shows an exemplary screen displaying a network diagram in an anomalous state;

FIG. 5 shows an exemplary screen displaying maintenance information on a selected one of robots; and

FIG. 6 is a flowchart for explaining a monitoring process of the monitoring device.

### PREFERRED MODE FOR CARRYING OUT THE INVENTION

### One Embodiment

A robot monitoring system according to one embodiment will be described in detail below with reference to the drawings. A network system including robots and a machine tool as industrial machines will be exemplified here. The present invention is applicable also to a network system including various machines, such as a machine tool, an industrial robot, a service robot, a forging press, a laser machine, and an injection machine, as industrial machines.

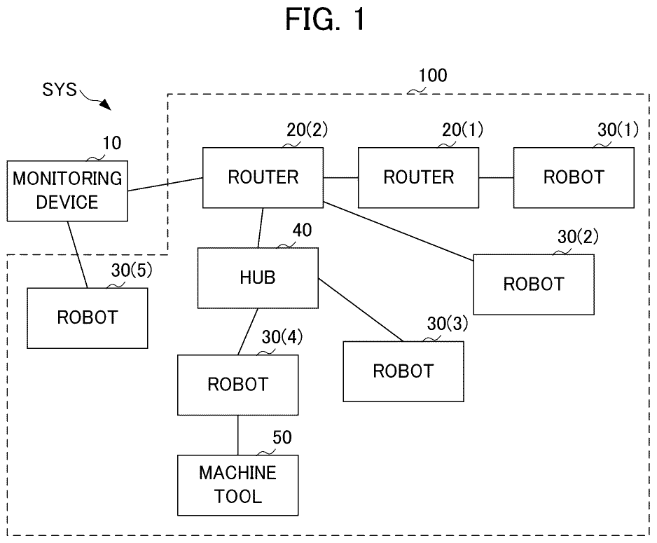

FIG. 1 shows an exemplary configuration of a robot monitoring system according to one embodiment.

As shown in FIG. 1, a robot monitoring system SYS includes, for example, a monitoring device 10, and a network system 100 to be monitored.

The network system 100 includes a plurality of components such as two routers 20(1) and 20(2), five robots 30(1) to 30(5), a hub 40, and a machine tool 50. The network system 100 may be intended for one factory or for two or more factories.

The monitoring device 10 of the robot monitoring system SYS shown in FIG. 1 is connected, for example, through the router 20(2) to the network system 100, and is directly connected to the robot 30(5) of the network system 100.

The monitoring device 10 and the network system 100 may be directly connected together through the router 20(2) and the robot 30(5) in a wired or wireless manner, or may be connected together through a network (not shown), such as a local area network (LAN).

The routers 20(1) and 20(2) and the hub 40 are network devices, such as routers and a switching hub, which have been known to those skilled in the art. These network devices allow the monitoring device 10 to communicate with the components of the industrial machines such as the robots 30(1) to 30(4) and the machine tool 50.

The robots 30(1) to 30(5) include, for example, a robot control device (not shown), and are robots that have been known to those skilled in the art and that operate based on a control instruction from the robot control device (not shown). All of the robots 30(1) to 30(5) may be six-axis articulated robots or any other articulated robots of the same type, for example. Alternatively, the robots 30(1) to 30(5) may be robots of different types, such as a six-axis articulated robot or any other articulated robot, a Cartesian coordinates robot, and a parallel link robot.

If the robots 30(1) to 30(5) do not have to be distinguished from one another, these robots are hereinafter simply referred to also as the “robots 30”.

The machine tool 50 has been known to those skilled in the art who machine a workpiece (not shown) in cooperation with the robot 30(4), for example.

The network system 100 may include a peripheral device, such as a belt conveyor. The network system 100 may further include a server, such as a plurality of data servers that save robot monitoring recording data indicating the operating states of the robots 30 to be transmitted to the monitoring device 10 by the robots 30 themselves, and an integrated server into which the plurality of data servers are merged.

### Monitoring Device 10

The monitoring device 10 monitors the status of the network in the network system 100. For this purpose, the monitoring device 10 receives the robot monitoring recording data indicating the states of the robots 30 (such as the positions (angles) of joint axes of each robot 30 and whether each robot 30 is on or off) 4 the robots 30. The monitoring device 10 may receive data indicating the states of the routers 20(1) and 20(2) and the hub 40 (such as an ACK signal) from the routers 20(1) and 20(2) and the hub 40. The monitoring device 10 may receive data indicating the state of the machine tool 50 (such as the rotation speed of a main shaft) from the machine tool 50.

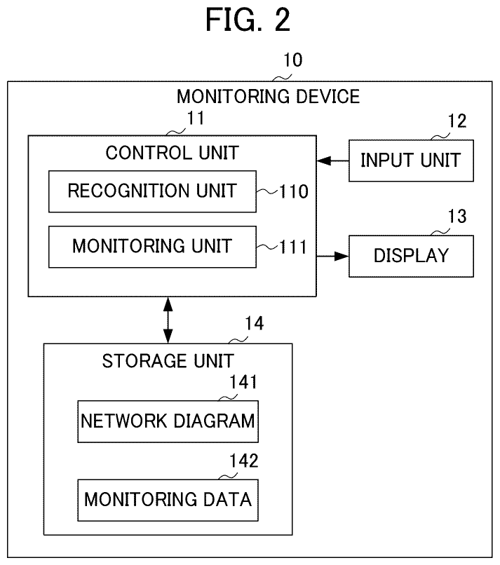

FIG. 2 shows an exemplary functional configuration of the monitoring device 10.

As shown in FIG. 2, the monitoring device 10 includes a control unit 11, an input unit 12, a display unit 13, and a storage unit 14. The control unit 11 includes a recognition unit 110 and a monitoring unit 111.

### Input Unit 12

The input unit 12 is, for example, a keyboard or a touch panel on the display unit 13 to be described later, and accepts input from a user, such as a network administrator.

### Display Unit 13

The display unit 13 is, for example, a liquid crystal display, and displays a network diagram or any other similar diagram of the network system 100 stored in the storage unit 14 as will be described later.

### Storage Unit 14

The storage unit 14 is, for example, a read only memory (ROM), a random access memory (RAM), a solid state drive (SSD), or a hard disk drive (HDD). The storage unit 14 may store a monitoring program or any other program in the robot monitoring system SYS. The storage unit 14 includes a network diagram 141 and monitoring data 142.

The network diagram 141 includes information on the layout and connection of the components such as the routers 20(1) and 20(2), the robots 30(1) to 30(5), the hub 40, and the machine tool 50 in the network system 100 including the monitoring device 10. The network diagram 141 may include address information indicating an IP address set for each component. The network diagram 141 may include information indicating the connection start date when the components are connected together and comments on the components, and other types of information.

The robot monitoring recording data indicating the states of the robots 30 received from the associated robots 30 (such as the positions of joint axes of each robot 30 and whether each robot 30 is on or off) are stored in the monitoring data 142 for each robot 30. Data indicating the states of the routers 20(1) and 20(2) and the hub 40 (such as an ACK signal) may be stored in the monitoring data 142 for each of the routers 20(1) and 20(2) and the hub 40. Data indicating the state of the machine tool 50 (such as the rotation speed of the main shaft) may be stored in the monitoring data 142. Data stored in the monitoring data 142 are supposed to include IP addresses of the routers 20(1) and 20(2), the robots 30(1) to 30(5), the hub 40, and the machine tool 50 indicating sources.

### Control Unit 11

The control unit 11 includes a central processing unit (CPU), a read only memory (ROM), a random access memory (RAM), and a complementary metal-oxide-semiconductor (CMOS) memory, which are configured to be able to communicate with one another via a bus. Such a controller 11 has been known to those skilled in the art.

The CPU is a processor that controls the monitoring device 10 as a whole. The CPU reads a system program and an application program stored in the ROM via the bus, and controls the entire monitoring device 10 in accordance with the system program and the application program. Thus, as shown in FIG. 2, the control unit 11 is configured to implement the functions of the recognition unit 110 and the monitoring unit 111. The RAM stores various data, such as temporary calculation data and display data. The CMOS memory is backed up by a battery (not shown), and is configured as a nonvolatile memory that maintains its storage state even with the monitoring device 10 turned off.

The recognition unit 110 recognizes at least one of the components such as the routers 20(1) and 20(2), the robots 30(1) to 30(5), the hub 40, and the machine tool 50.

Specifically, the recognition unit 110 recognizes the components such as the routers 20(1) and 20(2), the robots 30(1) to 30(5), the hub 40, and the machine tool 50, based on, for example, the address information in the network diagram 141 and the IP addresses included in the monitoring data 142.

The monitoring unit 111 monitors the communication states of the recognized components.

Specifically, in a case in which data on the recognized components, such as the router 20(1) and the robot 30(1), are not stored in (received by) the monitoring data 142 from a certain time of day to the present time based on the monitoring data 142, the monitoring unit 111 senses a communication blackout in the router 20(1) and the robot 30(1).

In a case in which the monitoring data 142 include data indicating deactivation of a robot 30, the monitoring unit 111 may sense deactivation of the robot 30, i.e., a communication blackout in the robot 30.

In a case in which a data transmission destination, for example, is not set for a robot 30 to be the monitoring device 10 based on the monitoring data 142, the monitoring unit 111 may sense that the data transmission destination is not set for the robot 30 serving as a client to be the monitoring device 10.

In a case in which the traffic exceeding a predetermined threshold value set in advance for communication between the components, such as between the monitoring device 10 and the robot 30(5), has been acquired based on the monitoring data 142, the monitoring unit 111 may sense that an anomalous condition occurs in a portion of the network between the monitoring device 10 and the robot 30 (5).

The monitoring unit 111 displays the network diagram 141 and the result of monitoring on the display unit 13.

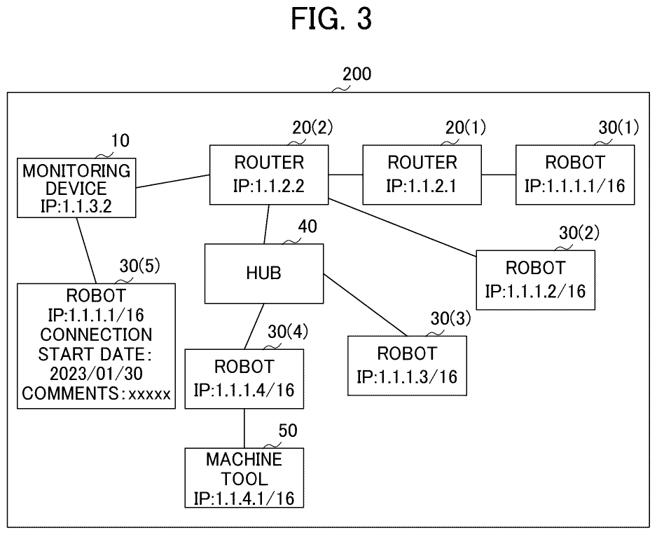

FIG. 3 shows an exemplary screen displaying a network diagram in a normal state. As shown in FIG. 3, a screen 200 indicates the network diagram of the network system 100 in FIG. 1 in a situation where the network is normal. The screen 200 may display the IP addresses of the components such as the routers 20(1) and 20(2), the robots 30(1) to 30(5), and the machine tool 50. The screen 200 may display the connection start date and the comments as is the case with the robot 30(5).

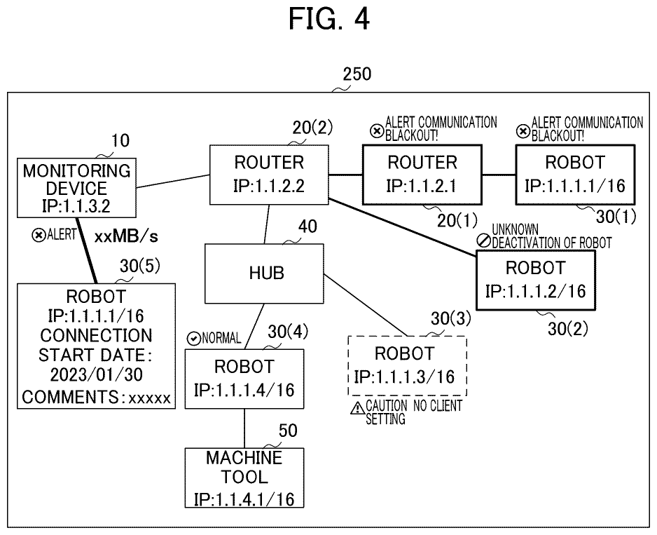

FIG. 4 shows an exemplary screen displaying the network diagram in an anomalous state. For example, in a case in which data from the router 20(1) and the robot 30(1) are not stored in (received by) the monitoring data 142, and the monitoring unit 111 senses a communication blackout in the router 20(1) and the robot 30(1), a screen 250 indicates the router 20(1), the robot 30(1), and corresponding ones of paths by the thick lines, and displays an alert sign and “COMMUNICATION BLACKOUT!” as shown in FIG. 4.

In a case in which the monitoring data 142 include data indicating deactivation of the robot 30(2), and the monitoring unit 111 senses deactivation of the robot 30(2), the screen 250 indicates the robot 30(2) and a corresponding one of the paths by the thick lines, and displays an “unknown” sign and “DEACTIVATION OF ROBOT”.

In a case in which the monitoring unit 111 senses that, based on the monitoring data 142, the data transmission destination is not set for the robot 30(3) serving as the client to be the monitoring device 10, the screen 250 indicates the robot 30(3) by the dashed lines, and displays a caution sign and “NO CLIENT SETTING”.

In a case in which the traffic exceeding the predetermined threshold value set in advance between the monitoring device 10 and the robot 30(5) has been acquired in the monitoring data 142, and the monitoring unit 111 senses that an anomalous condition has occurred in a portion of the network between the components such as between the monitoring device 10 and the robot 30(5), the screen 250 indicates the path between the monitoring device 10 and the robot 30(5) by the thick line, and displays an alert sign and “xx MB/s” indicating the present traffic.

For example, in a case in which the input unit 12 accepts input performed by the user to select the robot 30(2) on the screen 250, the monitoring unit 111 causes the screen 250 to transition to a screen indicating maintenance information on the selected robot 30(2), and displays this screen on the display unit 13.

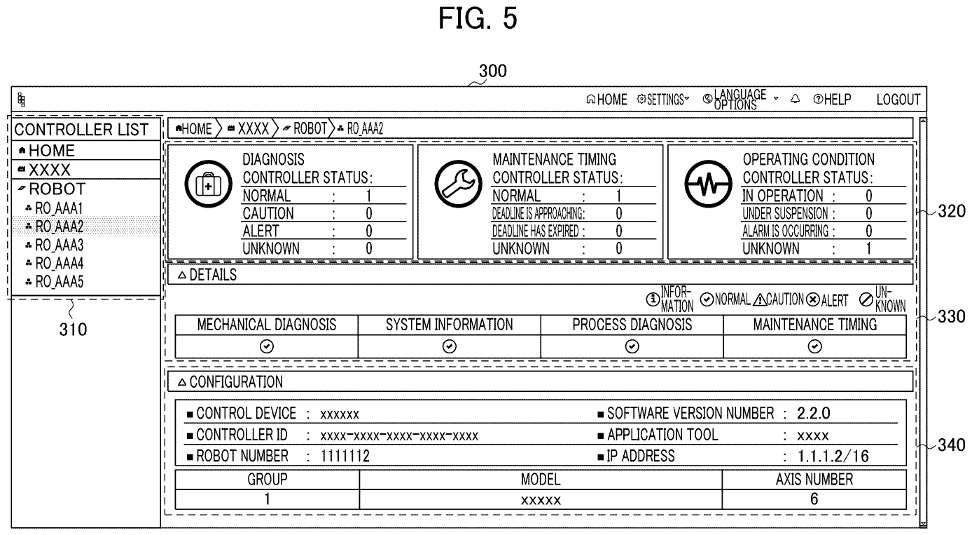

FIG. 5 shows an exemplary screen displaying the maintenance information on the selected robot 30(2). In FIG. 5, the robots 30(1) to 30(5) are named as “RO_AAA1” to “RO_AAA5”. In FIG. 5, a controller list indicates only the names of the robots 30(1) to 30(5), but may include the names of the peripheral devices such as the routers 20(1) and 20(2), the hub 40, and the machine tool 50.

As shown in FIG. 5, a screen 300 has, for example, a display region 310 indicating the controller list, a display region 320 indicating the results of “diagnosis”, the “maintenance timing”, and the “operating status” of the robot 30(2), and a display region 330 indicating “details”, and a display region 340 indicating a “configuration” of the robot 30(2).

This allows the user to easily grasp the status of the network in the network system 100 and an error, resulting in prompt discovery of a problem on the network.

For example, if, on the screen 250, the input unit 12 accepts input performed by the user to select the robot 30(1) in which a communication blackout has occurred, the monitoring unit 111 may display the screen 300 indicating maintenance information, as the maintenance information on the selected robot 30(1), on the display unit 13, based on the latest data received by the time when the communication blackout occurs.

### Monitoring Process of Monitoring Device 10

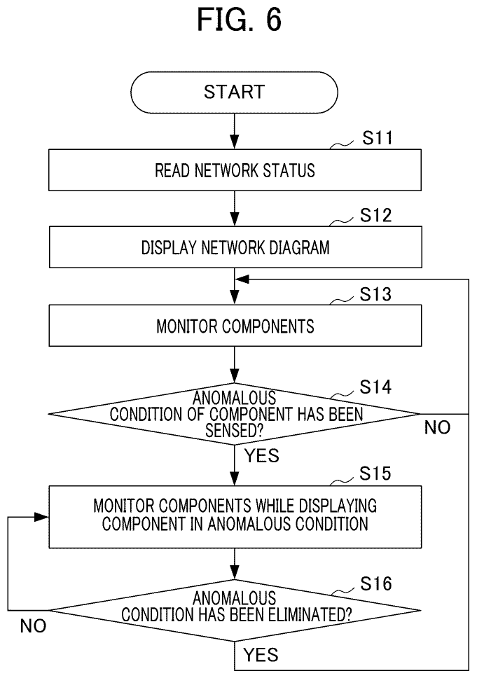

Next, the flow of a monitoring process of the monitoring device 10 will be described with reference to FIG. 6.

FIG. 6 is a flowchart for explaining the monitoring process of the monitoring device 10.

In Step S11, the recognition unit 110 recognizes the components based on the address information in the network diagram 141 and the IP addresses included in the monitoring data 142, and reads the monitoring data 142 on the components as the status of the network in the network system 100.

In Step S12, the monitoring unit 111 displays the screen 200 indicating the network diagram 141 on the display unit 13.

In Step S13, the monitoring unit 111 monitors the components based on the monitoring data 142.

In Step S14, the monitoring unit 111 determines whether or not an anomalous condition of a component, such as a communication blackout, has been sensed. In a case in which the anomalous condition of the component has been sensed, the process proceeds to Step S15. On the other hand, in a case in which the anomalous condition of the component has not been sensed, the process returns to Step S13.

In Step S15, the monitoring unit 111 monitors the components except the component in the anomalous condition while displaying, on the display unit 13, the screen 250 indicating the component in the anomalous condition sensed in Step S14 using the network diagram 141.

In Step S16, the monitoring unit 111 determines whether or not the anomalous condition sensed in Step S14 has been eliminated. In a case in which the anomalous condition has been eliminated by restoration work for the component in the sensed anomalous condition, the process returns to Step S13. On the other hand, in a case in which the anomalous condition has not been eliminated by restoration work for the component in the sensed anomalous condition, the process returns to Step S15.

In the foregoing manner, the monitoring device 10 according to the one embodiment can easily grasp the status of the network and the error by monitoring the network system 100 including the robots 30 and visually displaying the status of the network using the network diagram or any other method based on the result of monitoring.

This can result in prompt discovery of a problem on the network.

As described above in the one embodiment, the monitoring device 10 can easily grasp the status of the network and the error by monitoring the network system including the robots and visually displaying the status of the network using the network diagram or any other method based on the result of monitoring.

### Variations

In the one embodiment, the monitoring device 10 indicates the component in the anomalous condition by the thick lines or the dashed lines on the display unit 13. However, this is merely an example. For example, the monitoring device 10 may display the component in the anomalous condition in a color, such as red or yellow, or may highlight the component in the anomalous condition.

The functions included in the monitoring device 10 of the one embodiment may be implemented by hardware, software, or a combination thereof. A situation where something is implemented by software means that something is implemented by a computer reading and executing a program.

The program can be stored using any one of various types of non-transitory computer readable media, and can be supplied to the computer. The non-transitory computer readable media include various types of tangible storage media. Examples of the non-transitory computer readable media include magnetic recording media (e.g., a flexible disk, a magnetic tape, and a hard disk drive), magneto-optical recording media (e.g., a magneto-optical disk), a CD-ROM (read only memory), a CD-R, a CD-R/W, and semiconductor memories (e. g., a mask ROM, a PROM (a programmable ROM), an EPROM (an erasable PROM), a flash ROM, and a RAM). The program can be supplied to the computer using any one of various types of transitory computer readable media. Examples of the transitory computer readable media include an electric signal, an optical signal, and an electromagnetic wave. The transitory computer readable media can supply the program to the computer via a wired communication path, such as an electric wire or an optical fiber, or a wireless communication path.

The step of describing the program to be recorded in a storage medium includes processes to be executed in parallel or individually without necessarily executing the processes on a time-series basis, in addition to processes to be performed in chronological order on a time-series basis. The step of describing the program may be performed by cloud computing.

While the present disclosure has been described in detail, the present disclosure should not be limited to the individual embodiments described above. Various additions, replacements, changes, partial deletions, and the like can be made to the embodiments without departing from the gist of the disclosure or without departing from the idea and the meaning of the present disclosure derived from the content described in the claims and equivalents of the claims. These embodiments can be implemented in combination. While, in the foregoing embodiments, the order of operations and the order of processes are illustrated as examples, the orders should not be limited to those described above. The same statement applies to a case where the description of the foregoing embodiments includes numeric values or formulae.

The following additional remarks given to the embodiments and variations are further disclosed.

### Additional Remark 1

A monitoring device (10) monitors a network system (100) having a plurality of components including an industrial machine, a server, a peripheral device, and a network device. The industrial machine includes at least a robot (30). The monitoring device (10) includes: at least one memory (14) configured to store a network diagram (141) that shows a condition of connection between the plurality of components in the network system (100) and data (142) that indicate states of the plurality of components; at least one processor (11); and a display (13). The at least one processor (11) is configured to recognize at least one of the plurality of components, monitor a state of communication of the at least one of the components recognized based on the data (142), and display information that indicates a communication blackout in the at least one of the components recognized and the network diagram (141) on the display (13) in a case in which the communication blackout has occurred in the at least one of the components.

### Additional Remark 2

In the monitoring device (10) described in the additional remark 1, in a case in which a traffic exceeding a predetermined threshold value between the components is acquired, the at least one processor (11) determines that an anomalous condition has occurred in the network system (100).

### Additional Remark 3

In the monitoring device (10) described in the additional remark 1 or the additional remark 2, the at least one processor (11) displays the at least one of the components in which a communication blackout has occurred on the display (13) in a highlighted manner or in a marked manner.

### Additional Remark 4

In the monitoring device (10) described in the additional remark 1 or the additional remark 2, the at least one processor (11) displays the component in which a communication blackout has occurred and circumstances observed when the communication blackout occurs on the display (13).

### EXPLANATION OF REFERENCE NUMERALS

10 Monitoring Device
11 Control Unit
110 Recognition Unit
111 Monitoring Unit
12 Input Unit
13 Display Unit
14 Storage Unit
141 Network Diagram
142 Monitoring Data
20(1), 20(2) Router
30(1) to 30(5) Robot
40 Hub
50 Machine Tool
100 Network System
200, 250, 300 Screen
SYS Robot Monitoring System

1. A monitoring device for monitoring a network system having a plurality of components including an industrial machine, a server, a peripheral device, and a network device, the industrial machine including at least a robot, the monitoring device comprising:
at least one memory configured to store a network diagram that shows a condition of connection between the plurality of components in the network system and data that indicate states of the plurality of components;
at least one processor; and
a display,
the at least one processor being configured to
recognize at least one of the plurality of components,
monitor a state of communication of the at least one of the components recognized based on the data, and
display information that indicates a communication blackout in the at least one of the components recognized and the network diagram on the display in a case in which the communication blackout has occurred in the at least one of the components.

2. The monitoring device according to claim 1, wherein
in a case in which a traffic exceeding a predetermined threshold value between the components is acquired, the at least one processor determines that an anomalous condition has occurred in the network system.

3. The monitoring device according to claim 1, wherein
the at least one processor displays the at least one of the components in which a communication blackout has occurred on the display in a highlighted manner or in a marked manner.

4. The monitoring device according to claim 1, wherein
the at least one processor displays the component in which a communication blackout has occurred and circumstances observed when the communication blackout occurs on the display.
